(19) United States
(12) Patent Application Publication
(10) Pub. No.: US 2010/0229693 A1
(43) Pub. Date: Sep. 16, 2010

(54) DETACHABLE SCREWDRIVER ASSEMBLY

(76) Inventor: Kun-Chen CHEN, Dajia Chen (TW)

Correspondence Address: PATENTTM.US, P. O. BOX 82788, PORTLAND, OR, 97282-0788, US

(21) Appl. No.: 12/402,285

(22) Filed: Mar. 11, 2009

(51) Int. Cl. B25B 13/46; B25B 23/00; B23B 31/28

(52) U.S. Cl. 81/60; 81/438; 279/128

(57) ABSTRACT

A detachable screwdriver assembly has a handle, a connecting tube, a workpiece. The handle is rubber or plastic. The connecting tube is mounted in the handle and has a tool mount. The workpiece is a mounting shaft. The mounting shaft is detachably mounted in the tool mount of the connecting tube and has a mounting end, a tool slot, a chuck and a tool head. The mounting end of the mounting shaft protrudes from the tool mount of the connecting tube. The tool slot is formed in the mounting end. A chuck is slidably mounted around the mounting end. The tool head is detachably mounted in the tool slot and is held by the chuck.

### BACKGROUND OF THE INVENTION

1. Field of the Invention

The present invention relates to a detachable screwdriver assembly, and more particularly to a detachable screwdriver having a connecting tube with changeable workpiece for improved convenience and versatility.

2. Description of Related Art

With reference to FIG. 10, a conventional detachable screwdriver comprises a handle (50), a connecting tube (51) and a tool head (54).

The handle (50) is rubber or plastic.

The connecting tube (51) is metal and is mounted in the handle (50), and has a proximal segment, a distal segment and a tool mount (52), and comprises a magnet (53). The proximal segment of the connecting tube (51) is mounted in the handle (50). The distal segment protrudes from the handle (50). The tool mount (52) is hexagonal and is formed in the distal end of the connecting tube (51). The magnet (53) is mounted in the tool mount (52) of the connecting tube (51).

The tool head (54) is magnetic and has an inserting end (56) and a work end (55). The inserting end (56) is hexagonal in cross section, and is detachably mounted in the tool mount (52) of the connecting tube (51) and is attracted by the magnet (53). The work end (55) is a screwdriver head.

In use, the tool head (54) can be detachably mounted in the tool mount (52) of the connecting tube (51), and be easily removed and changed with a different size or type according to different jobs.

However, the connecting tube (51) of the detachable screwdriver can only be connected to tool heads (54) with fixed size or type. Therefore, the detachable screwdriver has limited application and use. The detachable screwdriver is not easy to use.

To overcome the shortcomings, the present invention tends to provide a detachable screwdriver assembly to mitigate or obviate the aforementioned problems.

### SUMMARY OF THE INVENTION

The main objective of the invention is to provide a detachable screwdriver assembly having a connecting tube with changeable workpiece for improved convenience and versatility.

The detachable screwdriver assembly has a handle, a connecting tube and a workpiece. The handle is rubber or plastic. The connecting tube is mounted in the handle and has a tool mount. The workpiece is a mounting shaft. The mounting shaft is detachably mounted in the tool mount of the connecting tube and has a mounting end, a tool slot, a chuck and a tool head. The mounting end of the mounting shaft protrudes from the tool mount of the connecting tube. The tool slot is formed in the mounting end. A chuck is slidably mounted around the mounting end. The tool head is detachably mounted in the tool slot and is held by the chuck.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a detachable screwdriver assembly in accordance with the present invention;

FIG. 2 is a partially exploded perspective view of the detachable screwdriver assembly in FIG. 1;

FIG. 3 is a side view in partial section showing the detachable screwdriver assembly in FIG. 1;

FIG. 4 is a side view in partial section showing the detachable screwdriver assembly in FIG. 1 further having a magnet;

FIG. 5 is a perspective view of the detachable screwdriver assembly in FIG. 1, where a handle has a ratchet;

FIG. 6 is a partially exploded perspective view of the detachable screwdriver assembly in FIG. 5 further having a gear ring on a connecting tube;

FIG. 7 is a side view in partial section showing the detachable screwdriver assembly in FIG. 1 connected to a direct tool head;

FIG. 8 is a perspective view of a mounting shaft of the detachable screwdriver assembly in FIG. 1 being used with an automatic tool;

FIG. 9 is a perspective view of the mounting shaft of the detachable screwdriver assembly in FIG. 1 being used with another automatic tool; and

FIG. 10 is a perspective view of a detachable screwdriver in accordance with the prior art.

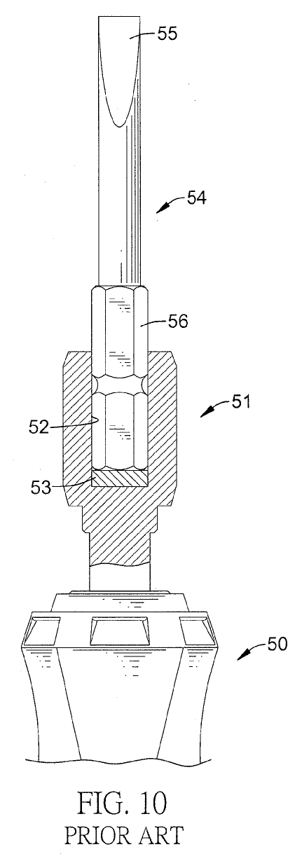

### DETAILED DESCRIPTION OF PREFERRED EMBODIMENT

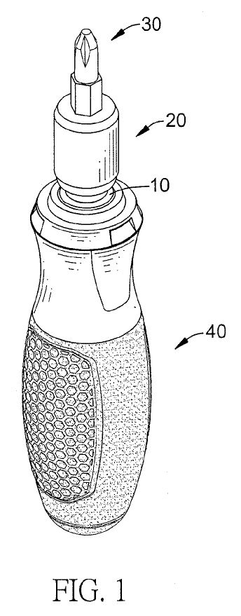

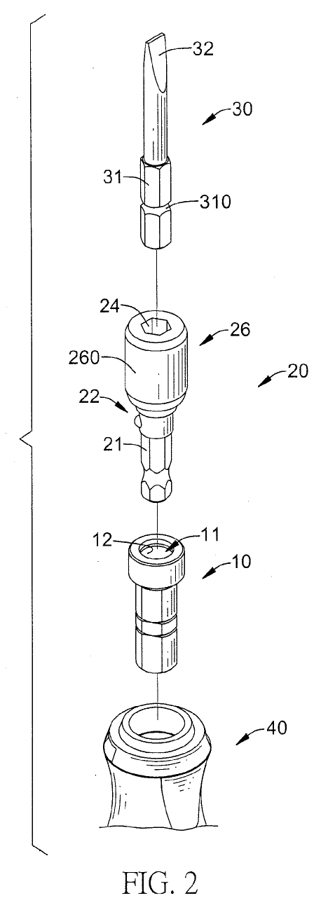

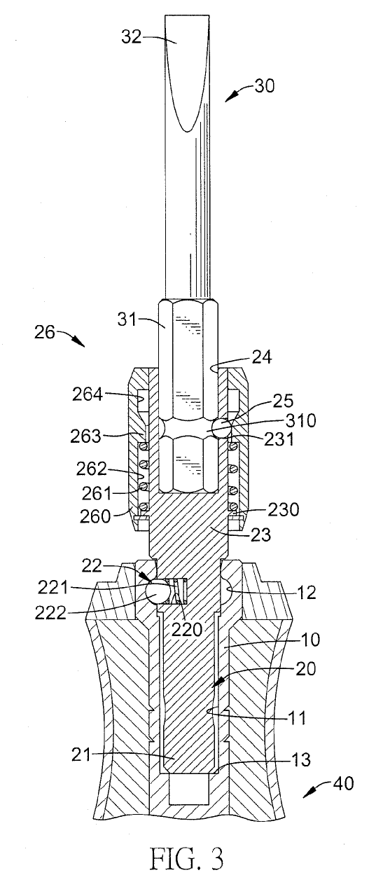

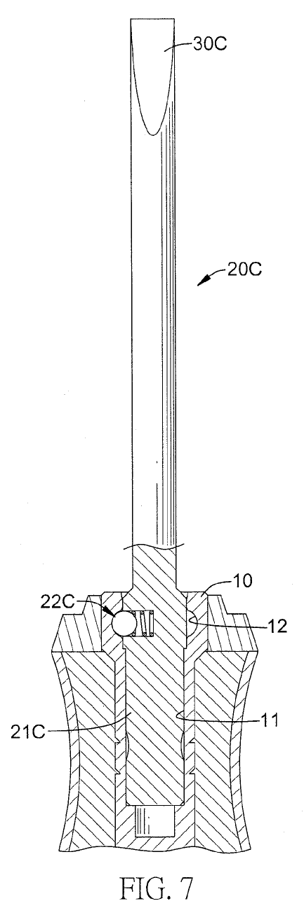

With reference to FIGS. 1 to 3 and 7, a detachable screwdriver assembly in accordance with the present invention comprises a handle (40), a connecting tube (10) and a workpiece.

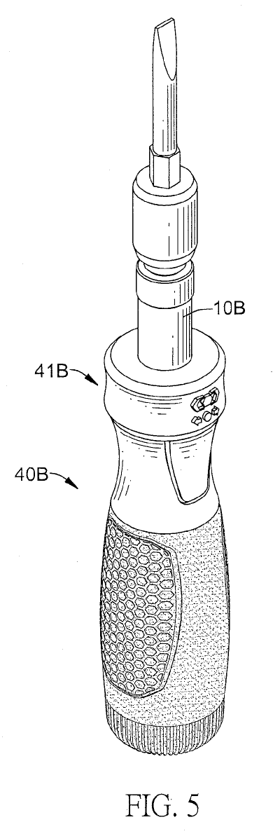

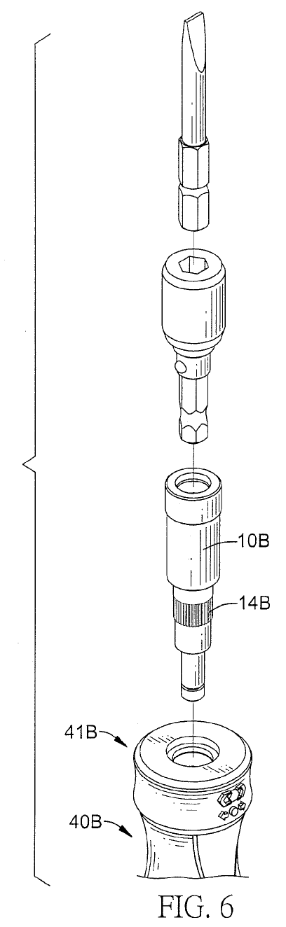

With further reference to FIGS. 5 and 6, the handle (40, 40B) is rubber or plastic and may have a ratchet (41B) formed thereon.

The connecting tube (10, 10B) is connected securely to and may be mounted in the handle (40, 40B), may be mounted in the ratchet (41B), and has a tool mount (11), a proximal segment, a distal segment, an engaging recess (12), an optional shoulder (13) and an optional gear ring (14B).

The tool mount (11) is formed in the connecting tube (10) and may be hexagonal. The proximal segment has an outer surface. The outer surface of the proximal segment is securely connected to the handle (40) and may be non-circular. The distal segment has an optional circular outer surface. The distal end of the connecting tube (10B) may be extended from the ratchet (41B) of the handle (40B).

The engaging recess (12) is formed in the tool mount (11) near the distal segment of the connecting tube (10) and may be annular. The shoulder (13) is formed on and narrows the tool mount (11). The gear ring (14B) is formed on the outer surface of the proximal segment of the connecting tube (10B). The gear ring (14B) of the connecting tube (10B) engages the ratchet (41B) of the handle (40B).

The workpiece is detachably mounted in the connecting tube (10), and may be a mounting shaft (20), and may be a direct tool head (20C). The mounting shaft (20) has an inserting end (21), a tool slot (24), a mounting end (23), an engaging element (22), a chuck (26) and a tool head (30). The inserting end (21) is mounted in the tool mount (11) of the connecting tube (10) and has a butt and may be hexagonal. The butt of the inserting end (21) abuts the shoulder (13) of the connecting tube (10).

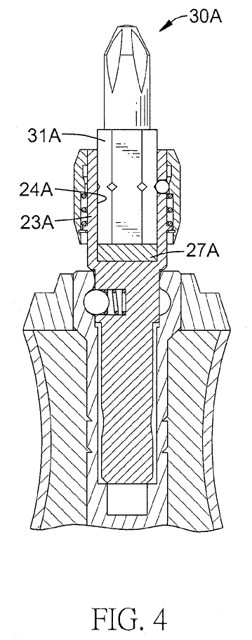

With further reference to FIG. 4, the tool slot (24) is formed longitudinally in the mounting end (23A), may be hexagonal and may comprise a magnet (27A). The magnet (27A) is mounted on the tool slot (24A) of the mounting end (23A) and provides a magnetic attraction.

The mounting end (23) protrudes from the tool mount (11) of the connecting tube (10) and has a spring mount (230), a hole (231), and may have a circular outer surface. The spring mount (230) protrudes from the outer surface of the mounting end (23). The hole (231) is formed through the mounting end (23) and communicates with the tool slot (24).

The engaging element (22) is movably mounted in the inserting end (21) and selectively engages the engaging recess (12) of the connecting tube (10). The engaging element (22) may comprise an engaging hole (220), an engaging spring (221) and an engaging ball (222). The engaging hole (220) is formed in the inserting end (21) and has a narrowed opening. The engaging spring (221) is mounted in the engaging hole (220). The engaging ball (222) is moveably mounted in the engaging hole (220), is pressed by the engaging spring (221) and selectively protrudes into the engaging recess (12) of the connecting tube (10).

The chuck (26) is mounted on the mounting end (23) of the mounting shaft (20) and comprises a ball (25), a sleeve (260) and a spring (261).

The ball (25) is moveably mounted in the hole (231) and selectively protrudes into the tool slot (24) of the mounting end (23) of the mounting shaft (20).

The sleeve (260) is slidably mounted around the mounting end (23) and has an inner surface, a spring recess (262), a ball protrusion (263) and a ball recess (264). The spring recess (262) is formed in the inner surface of the sleeve (26) and is disposed adjacent to the spring mount (230). The ball protrusion (263) protrudes from the inner surface of the sleeve (260) and selectively forces the ball (25) to protrude into the tool slot (24). The ball recess (264) is formed in the inner surface of the sleeve (260) adjacent to the ball protrusion (263) and selectively communicates with the hole (231) of the mounting end (23).

The spring (261) is mounted around the mounting end (23), in the spring recess (262) of the sleeve (260) and abuts the spring mount (230) of the mounting end (23) of the mounting shaft (20) to provide a returning force to the sleeve (260).

The tool head (30) is detachably mounted in the tool slot (24) and is held securely by the chuck (26), and has a chuck end (31) and a work end (32). The chuck end (31) is mounted in the tool slot (24), may be hexagonal and has an annular recess (310) and may be magnetically attracted to the magnet (27A) and engages the chuck (26). The annular recess (310) is formed in the chuck end (31) and securely engages the ball (25) of the chuck (26). The work end (32) protrudes from the tool slot (24) and may be a screwdriver head or the like.

The direct tool head (20C) is detachably mounted in the tool mount (11) of the connecting tube (10) and has a direct insertion end (21C), a direct engaging element (22C) and a direct work end (30C). The direct insertion end (21C) corresponds to and is mounted directly in the tool mount (11). The direct engaging element (22C) is formed in the direct insertion end (21C) of the direct tool head (20C) and selectively engages the engaging recess (12) of the connecting tube (10). The direct work end (30C) protrudes from the tool mount (11) and may be a screwdriver head or the like.

Therefore, the mounting shaft (20) with tool head (30) and direct tool head (20C) can be altered according to the different jobs, so fewer specific tools need be carried.

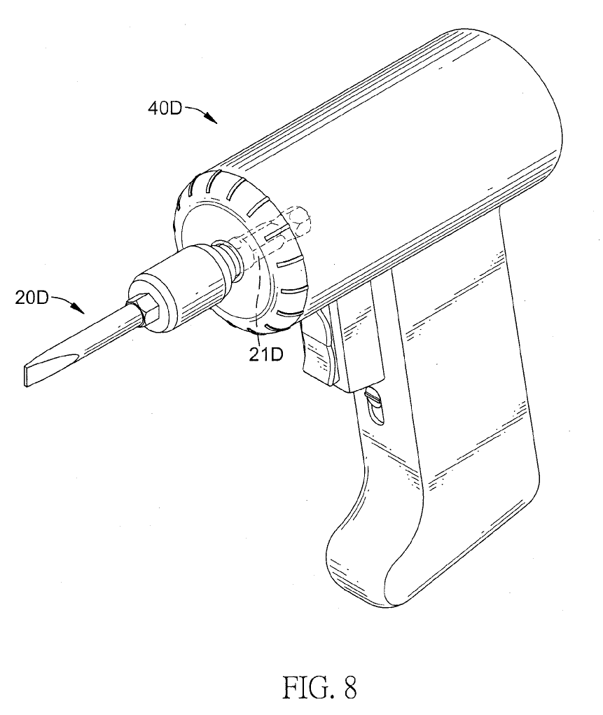

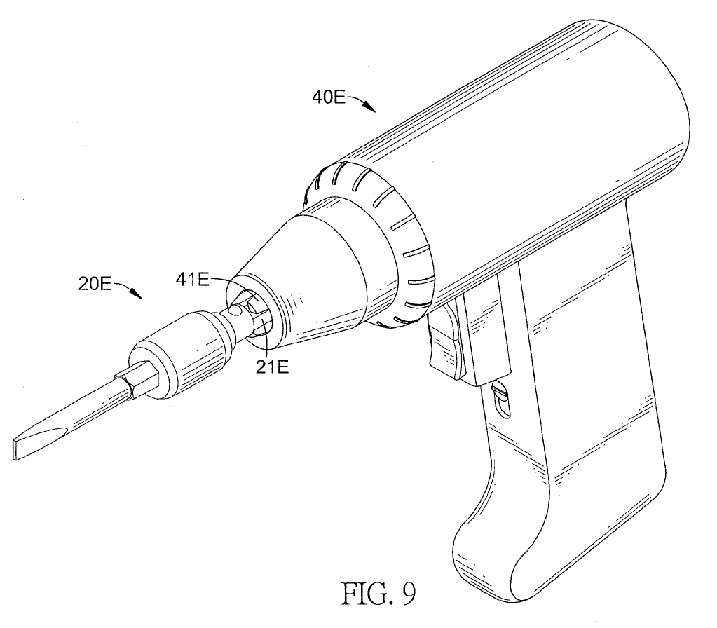

With further reference with FIG. 8 and 9, the mounting shaft (20D, 20E) can be detachably connected to an automatic tool (40D, 40E). The inserting end (21D, 21E) of the mounting shaft (20D, 20E) may be hexagonal and engage a tool mount (41D) of the automatic tool (40D), or may be clamped by a chuck (41E) of the automatic tool (40E).

However, the mounting shaft (20) and the direct tool head (20C) can be alternately, detachably mounted in the connecting tube (10) and may be changed. The tool head (30) is also detachably mounted in the mounting shaft (20) and may be changed according to different jobs. The handle (40) with the connecting tube (10) or the mounting shaft (20, 20C) can be changed when one of them is broken.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A detachable screwdriver assembly comprising:
a handle;
a connecting tube being connected securely to the handle and having
a tool mount being formed in the connecting tube; and
an engaging recess being formed in the tool mount of the connecting tube;
a workpiece being detachably mounted in the connecting tube and having
an inserting end being mounted in the tool mount of the connecting tube;
an engaging element being movably mounted in the inserting end and selectively engaging the engaging recess of the connecting tube and having
an engaging hole being formed in the inserting end;
an engaging spring being mounted in the engaging hole; and
an engaging ball being moveably mounted in the engaging hole and being pressed by the engaging spring and selectively protruding into the engaging recess of the connecting tube.

2. The detachable screwdriver assembly as claimed in claim 1, wherein
the workpiece is a mounting shaft and further has
a mounting end protruding from the tool mount of the connecting tube;
a tool slot being formed longitudinally in the mounting end;
a chuck being mounted on the mounting end of the mounting shaft; and
a tool head having a chuck end being detachably mounted in the tool slot and being held securely by the chuck.

3. The detachable screwdriver assembly as claimed in claim 2, wherein the mounting end of the mounting shaft further has
an outer surface;
a spring mount protruding from the outer surface of the mounting end; and
a hole formed through the mounting end and communicating with the tool slot; and
the chuck of the mounting shaft further has
a ball being mounted in the hole of the mounting end of the mounting shaft, and selectively protruding into the tool slot of the mounting shaft;
a sleeve being slidably mounted around the mounting end and having
an inner surface;
a spring recess being formed in the inner surface of the sleeve;
a ball protrusion protruding from the inner surface of the sleeve; and
a ball recess being formed in the inner surface of the sleeve and selectively communicating with the hole of the mounting end of the mounting shaft; and
a spring being mounted in the mounting end in the spring recess of the sleeve.

4. The detachable screwdriver assembly as claimed in claim 2, wherein the tool head further has
a chuck end being mounted in the tool slot and having
an annular recess being formed in the mounting end of the tool head and engaging the chuck; and
a work end being a screwdriver head and protruding from the tool slot.

5. The detachable screwdriver assembly as claimed in claim 3, wherein the tool head further has
a chuck end being mounted in the tool slot and having
an annular recess being formed in the mounting end of the tool head and engaging the chuck; and
a work end being a screwdriver head and protruding from the tool slot.

6. The detachable screwdriver assembly as claimed in claim 2 further has a magnet being mounted in the tool slot of the mounting end of the mounting shaft.

7. The detachable screwdriver assembly as claimed in claim 5 further has a magnet being mounted in the tool slot of the mounting end of the mounting shaft.

8. The detachable screwdriver assembly as claimed in claim 1, wherein
the workpiece is a direct tool head and further has a direct work end protruding from the tool mount and being a screwdriver head.

9. The detachable screwdriver assembly as claimed in claim 1 further having a ratchet on the handle, wherein the connecting tube further has
an outer surface; and
a gear ring being formed on the outer surface of the connecting tube and engaging the ratchet of the handle.

10. The detachable screwdriver assembly as claimed in claim 2 further having a ratchet on the handle, wherein the connecting tube further has
an outer surface; and
a gear ring being formed on the outer surface of the connecting tube and engaging the ratchet of the handle.

11. The detachable screwdriver assembly as claimed in claim 7 further having a ratchet on the handle, wherein the connecting tube further has
an outer surface; and
a gear ring being formed on the outer surface of the connecting tube and engaging the ratchet of the handle.

12. The detachable screwdriver assembly as claimed in claim 8 further having a ratchet on the handle, wherein the connecting tube further has
an outer surface; and
a gear ring being formed on the outer surface of the connecting tube and engaging the ratchet of the handle.
